(19) United States
(12) Patent Application Publication
(10) Pub. No.: US 2006/0154802 A1
(43) Pub. Date: Jul. 13, 2006

(54) Organo-clay complexes

(75) Inventors: Shmuel Yariv, East Binyamin (IL); Isaak Lapides, Jerusalem (IL); Hagai Peled, Tel Aviv (IL); Zohar Yirmiyahu, Zur Hadasa (IL)

Correspondence Address: FOLEY AND LARDNER LLP;SUITE 500, 3000 K STREET NW, WASHINGTON, DC, 20007, US

(73) Assignee: Yissum Research Development Company of the Hebrew University of Jerusalem

(21) Appl. No.: 10/517,984

(22) PCT Filed: Jun. 12, 2003
(86) PCT No.: PCT/IL03/00497

§ 371 Date: Jun. 24, 2005

(30) Foreign Application Priority Data
Jun. 19, 2002 (IL) 150317

(51) Int. Cl. B01J 29/04

(52) U.S. Cl. 502/60

(57) ABSTRACT

The invention provides a process for the preparation of a pigment which is an organo-clay complex comprising introducing an aniline derivative acidified by hydrochloric acid and a secondary aromatic compound into a smectite mineral and treating the same with sodium nitrite solution whereby an azo-dye compound is obtained in the interlayer space of the clay to form pigmented particles.

The present invention relates to a process for the preparation of a pigment which is an organo-clay complex. More particularly, the present invention relates to the in-situ preparation of azo-dye compounds adsorbed onto clay particles.

Clay minerals are famous for their ability to adsorb organic compounds. Among the clay minerals, montmorillonite and other smectite minerals-are the most useful for this purpose. The alumino- or magnesium silicate framework has a layer structure and in the crystal the layers are arranged one above the other. Each layer is negatively charged and the electric charge is neutralized by exchangeable cations, most of which are located in the interlayer space. The adsorbed organic cations and molecules are also located in the interlayer space.

Organic cationic dyes are adsorbed by the. smectite minerals causing the mineral to be colored. The colored mineral may be used as a pigment for the color industry. The subject was recently reviewed Yariv S. (2001) Staining of clay minerals and visible adsorption spectroscopy of dye-clay complexes in “Organo-lay complexes and interactions” (S. Yariv and H. Cross, editors) Marcel Dekker, Inc., New York, pp. 463-566. The adsorption of these dyes takes place mainly by the mechanism of cation exchange.

Azo-dyes are used. for different color applications. They are synthesized from aniline or its primary amine derivative, a second aromatic compound and sodium nitrite to yield products of the general formula Ar′—N═N—Ar″, called azo compounds. In this reaction, known as coupling, the nitrogen of the diazonium group is retained in the product.
Ar′N₂+Ar″H→Ar′—N═N—Ar″+H⁺

The aromatic ring of the second compound must, in general, contain a powerfully electron-releasing group, generally —NHR or —NH₂.

There are three papers in the literature which describe the adsorption of azo-dyes by expanding clay minerals. Siffert, B. (1978) Preparation et etude spectrometrique de complexessilicates phyllitteux colorants azoiques. Clay Miner., pp. 13: 147-165. Siffert studied vermiculite complexes of the cationic azo-dye chrysoidine and the molecular azo-dyes para-dimethylaminoazobenzene, bis(para-dimethyl-aminophenylazo)-orthotolidine, and bis(para-dimethylaminophenylazo)Diphenyl. Depending on the pH of the system, the dye adsorption occurs either by molecular or by cation exchange mechanism.

Gabelica, Z., Valange, S., Shibata, M., Hotta, H. (2001): Stability against color fading of azo-dyes encapsulated in Ca-aluminosilicate mesoporous substraes. Microporous and Mesoporous Materials, 44-45: 645-652. Gabelica et al. studied the adsorption of Lithol Rubine B by the synthetic clay MCM-41.

Yermiyahu., Z., Lapides, I., Yariv, S. (2000). Adsorption of Congo-Red by montmorillonite. Proc. Isr. Geological Soc., Annual Meeting, Ma'a lot 2000 (Abstracts), p. 131. Yermiyahu, et al. studied the adsorption of Congo-Red. by montmorillonite. This azo-dye is adsorbed by the clay mineral although it is an anionic species.

According to the present invention it has now been discovered that azo-dyes can be formed in-situ within natural and synthetic clay minerals of the smectite family, e.g., montmorillonite.

Thus according to the present invention there is now -provided a process for the preparation of a pigment which is an organo-clay complex comprising introducing an aniline derivative acidified by hydrochloric acid and a secondary aromatic compound into a smectite mineral and treating the same with sodium nitrate solution whereby an azo-dye compound is obtained in the interlayer space of the clay to form pigmented particles.

In preferred embodiments of the present invention said aniline derivative is selected from the group consisting. of anilinium chloride, naphthyl-ammonium chloride and benzidinium chloride and said secondary aromatic compound is selected from the group consisting of 2-hydroxy-naphthalene, 2,3-dihydroxynaphthalene, 4-amino-2-chlorotoluene-5-sulfonic acid, 2-chloro-4-aminotoluene and 2-hydroxy-1-napthoic acid.

While the invention will now be described in connection with certain preferred embodiments in the following examples so that aspects thereof may be. more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLES

The present pigments are prepared from different smectite minerals. Most of the work was carried out with montmorillonite and Laponite. The following examples and colors are related to montmorillonite.

### Example 1

To 20 ml of an aqueous 1% clay suspension, 1.0 ml of an aqueous solution of 0.1 molar of the salt 1-Naphthylammonium chloride was added and stirred. After two hours 2-Chloro-4-aminotoluene was added (1.0 ml of an aqueous or alcoholic solution of 0.1 molar) and the mixture was stirred for half an hour. 2.0 ml of aqueous solution of 0.1 molar NaNO₂ was added, and a violet color was developed immediately. The intensity of the color increased within 24 hours. After one week the solid fraction was washed three times with distilled water and was separated from the supernatant by centrifugation.

### Example 2

To 20 ml of an aqueous 1% clay suspension, 1.0 ml of an aqueous solution of 0.1 molar of the salt 1-Naphthylammonium chloride was added and stirred. After two hours 4-Amino-2-chlorotoluene-5-sulfonic Acid was added (1.0 ml of an aqueous or alcoholic solution of 0.1 molar) and the mixture was stirred for half an hour. 2.0 ml of aqueous solution of 0.1 molar NaNO₂ was added, and a red color was developed immediately. The intensity of the color increased within 24 hours. After one week the solid fraction was washed three times with distilled water and was separated from the supernatant by centrifugation.

### Example 3

To 20 ml of an aqueous 1% clay suspension, 1.0 ml of an aqueous solution of 0.1 molar of the salt Anilinium-chloride was added and stirred. After two hours 2,3-Dihydroxynaphthalene was added (1.0 ml of an aqueous or alcoholic solution of 0.1 molar) and the mixture was stirred for half an hour.

2.0 ml of aqueous solution of 0.1 molar NaNO₂ was added, and a red color was developed immediately. The intensity of the color increased within 24 hours. After one week the solid fraction was washed three times with distilled water and was separated from the supernatant by centrifugation.

### Example 4

To 20 ml of an aqueous 1% day suspension, 1.0 ml of an aqueous-solution of 0.1 molar of the salt 1-Naphthylammonium chloride was added and stirred. After two hours 1-Naphthylammonium chloride was added (1.0 ml of an aqueous or alcoholic solution of 0.1 molar) and the mixture was stirred for half an hour. 2.0 ml of aqueous solution of 0.1 molar NaNO₂ was added, and a blue color was developed immediately. The intensity of the color increased within 24 hours. After one week the solid fraction was washed three times with distilled water and was separated from the supernatant by centrifugation.

### Example 5

To 20 ml of an aqueous 1% clay suspension, 1.0 ml of an aqueous solution of 0.1 molar of the salt 1-Naphthylammonium chloride was added and stirred. After two hours 2,3-Dihydroxynaphthalene was added (1.0 ml of an aqueous or alcoholic solution of 0.1 molar) and the mixture was stirred for half an hour.

2.0 ml of aqueous solution of 0.1 molar NaNO₂ was added, and a violet color was developed immediately. The intensity of the color increased within 24 hours. After one week the solid fraction was washed three times with distilled water and was separated from the supernatant by centrifugation.

### Example 6

To 20 ml of an aqueous 1% clay suspension, 1.0 ml of an aqueous solution of 0.1 molar of the salt Anilinium-hydrochloride was added-and stirred. After two hours 2-Hydroxy-1-naphtoic acid was added (1.0 ml of an aqueous or alcoholic solution of 0.1 molar) and the mixture was stirred for half an hour.

2.0 ml of aqueous solution of 0.1 molar NaNO₂ was added, and a red color was developed immediately. The intensity of the color increased within 24 hours. After one week the solid fraction was washed three times with distilled water and was separated from the supernatant by centrifugation.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A process for the preparation of a pigment which is an organo-clay complex comprising introducing an aniline derivative acidified by hydrochloric acid and a secondary aromatic compound into a smectite mineral and treating the same with sodium nitrite solution whereby an azo-dye compound is. obtained in the interlayer space of said clay to form pigmented particles.

2. A process according to claim 1 wherein said aniline derivative is selected from the group consisting of anilinium chloride, naphthyl -ammonium chloride and benzidinium chloride.

3. A process according to claim 1 wherein said secondary aromatic compound is selected from the group consisting of 2-hydroxy-naphthalene, 2,3-dihydroxy-naphthalene, 4-amino-2-chlorotoluene-5-sulfonic acid, 2-chloro-4-aminotoluene and 2-hydroxy-1-napthoic acid.
